(19) United States
(12) Patent Application Publication
(10) Pub. No.: US 2007/0080205 A1
(43) Pub. Date: Apr. 12, 2007

(54) SYSTEM AND METHOD FOR TESTING A CARD READER OF A COMPUTER

(76) Inventors: Yong-Xing You, Shenzhen (CN); Feng-Long He, Shenzhen (CN); Yan-Feng Luo, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,734

(22) Filed: Apr. 27, 2006

(30) Foreign Application Priority Data
Sep. 15, 2005 (CN) 200510037325.8

(51) Int. Cl. G06F 17/00; G06K 7/00

(52) U.S. Cl. 235/375; 235/435

(57) ABSTRACT

A method for testing a card reader includes the steps of: identifying a logical drive corresponding to the card reader; determining whether the card reader matches a portable storage device connected to the card reader; displaying error information if the card reader does not match the portable storage device; obtaining a control code of the portable storage device if the card reader matches the portable storage device; testing the performance of the card reader by means of reading and writing data in the portable storage device through the card reader according to the control code.

### FIELD OF THE INVENTION

The present invention generally relates to systems and methods for testing ports of computer hardware devices, and more particularly to a system and method for testing a card reader of a computer.

### DESCRIPTION OF RELATED ART

With portable storage devices, such as flash memories, portable hard disks, digital photographic cameras, mp3s, and so on, developing and gaining popularity rapidly, it is often needed to exchange data between computers and the portable storage devices, and this is done with a card reader.

The card reader can transfer data between computers and periphery portable storage devices. The working principle of the card reader is that it serves as a data bridge between a computer and a portable storage device, thus allowing a processor to read/write data via the card reader in the periphery portable storage device.

Generally, for ensuring the validity of data transferred by the card reader, the working performance of the card reader, for example, the capabilities of its read-write functions, need to be tested. Previously, this test is done by using a manual method, such a manual method often results in some test functions of the card reader to be missed, leading to a wrong estimated working performance of the card reader.

What is needed, therefore, is a system and a method for testing a card reader of a computer, which can test capability of the card reader automatically instead of manual test, thus decreasing time, enhancing efficiency, and improving precision of analysis.

### SUMMARY OF INVENTION

A system for testing a card reader in accordance with a preferred embodiment includes a computer and a portable storage device. The card reader is installed in the computer and connected to the portable storage device. The computer further comprises a plurality of logical drives and a testing unit. The testing unit includes a plurality of function modules: an information obtaining module for obtaining information on the logical drives, the card reader, and the portable storage device; an identifying module for selecting a logical drive assigned to the card reader, and for determining whether the card reader port matches the portable storage device format; and a verifying module for testing the working performance of the card reader.

A method for testing a card reader of a computer in accordance with a preferred embodiment includes the steps of: obtaining information on logical drives of a computer, a card reader, and a portable storage device connected to the card reader; selecting a logical drive assigned to the card reader from a set of logical drives, and determining whether the card reader port matches the portable storage device format according to the information on the card reader and the portable storage device; and testing the working performance of the card reader by comparing data written into the portable storage device and data read from the portable storage device.

Other systems, methods, features, and advantages of the present invention will be or become apparent to one with skill in the art upon examination of the following drawings and detailed description.

### BRIEF DESCRIPTION OF DRAWINGS

FIG. 1 is a schematic diagram illustrating hardware configuration of a system for testing a card reader of a computer, in accordance with a preferred embodiment;

FIG. 2 is a schematic diagram illustrating function modules of a testing unit of FIG.1;

FIG. 3 is a flowchart illustrating a method for testing a card reader of a computer by utilizing the system of FIG. 1, in accordance with a preferred embodiment; and

FIG. 4 is a flowchart illustrating one step of FIG. 3 in detail, namely testing the working performance of the card reader.

### DETAILED DESCRIPTION

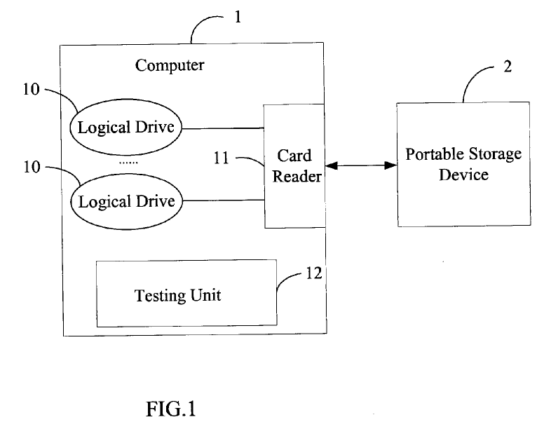

FIG. 1 is a schematic diagram illustrating hardware configuration of a system for testing a card reader of a computer (hereinafter, “the system”), in accordance with a preferred embodiment. The system typically includes a computer 1 and a portable storage device 2. The computer 1 further includes a plurality of logical drives 10, a card reader 11 connected between one of the logical drives 10 and the portable storage device 2, and a testing unit 12. The logical drives 10 are used for saving system data and user data, and may be referred as logical drives A, B, C, D, E, and so on. For example, in a typical computer system, the logical drive A or B may be a floppy drive; the logical drive C may be a system drive; the logical drive D may be a user data drive; and the logical drive E may be a CD-Rom. The card reader 11 can transfer data between the computer 1 and the portable storage device 2. The portable storage device 2 is a data storage device that may be a floppy diskette, a compact disc (CD), a portable hard disk, a flash memory card, etc. The testing unit 12 is used for testing the working performance of the card reader 11.

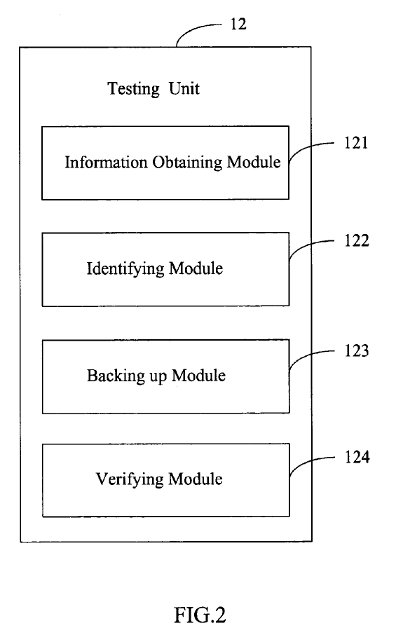

FIG. 2 is a schematic diagram illustrating function modules of the testing unit 12. The testing unit 12 includes an information obtaining module 121, an identifying module 122, a backing up module 123, and a verifying module 124.

The information obtaining module 121 is used for obtaining information on the logical drives 10, the card reader 11, and the portable storage device 2. Such information may include the type of each logical drive 10, a port protocol of the card reader 11, and a working state of the portable storage device 2. The identifying module 122 is used for selecting a logical drive 10 assigned to the card reader 11 from a set of logical drives 10, and for determining whether the card reader 11 port matches the type of portable storage device 2 format according to the information on the card reader 11 and on the portable storage device 2. The backing up module 123 is used for backing up data of the portable storage device 2 to the selected logical drive 10, in order to prevent existing data of the portable storage device 2 from being destroyed. The verifying module 124 is used for testing the working performance of the card reader 11 by comparing data written into the portable storage device 2 and data read from the portable storage device 2.

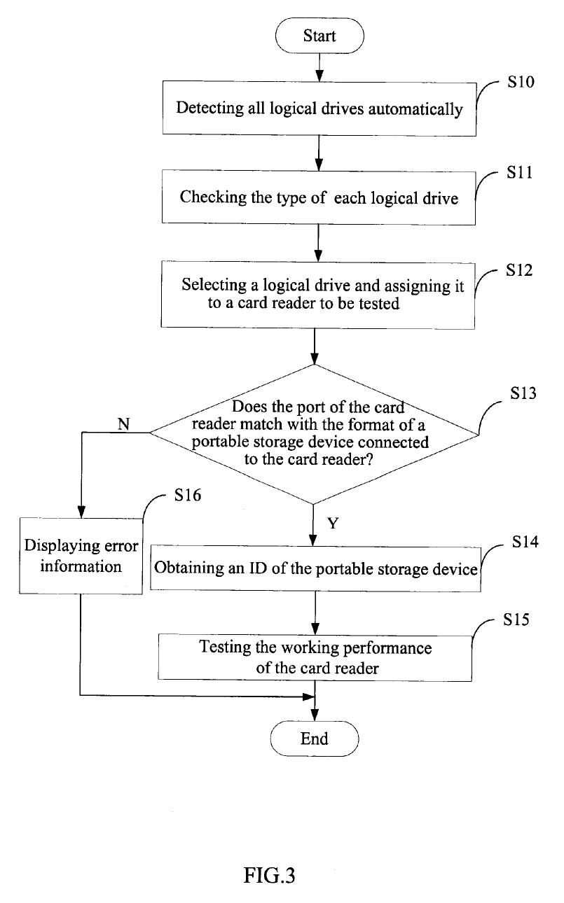

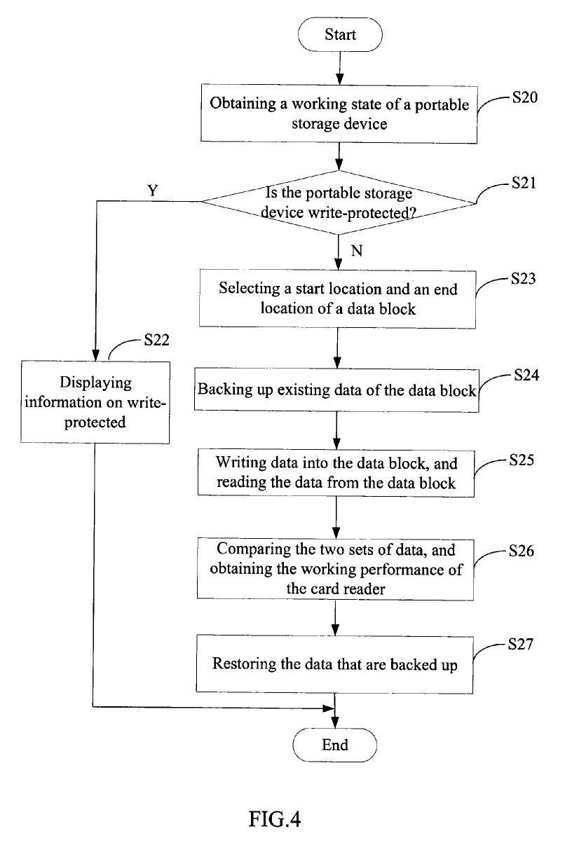

FIG. 3 is a flowchart illustrating a method for testing a card reader of a computer by utilizing the system of FIG. 1, in accordance with a preferred embodiment. In step S10, the information obtaining module 121 automatically detects all logical drives 10 in the system. In step S11, the information obtaining module 121 checks the type of each logical drive 10, namely identifies the logical drive A, B, C, D, E and so on. In step S12, the identifying module 122 selects a logical drive 10 and assigns it to the card reader 11. In step S13, the identifying module 122 judges whether the port of the card reader 11 matches the format of the portable storage device 2 connected to the card reader 11 according to a port protocol of the card reader 11 and a working state of the portable storage device 2. If the port of the card reader 11 matches the format of the portable storage device 2, in step S14, the information obtaining module 121 obtains an ID of the portable storage device 2. In step S15, the verifying module 124 reads data from the portable storage device 2 according to the ID of the portable storage device 2, and writes the data into the logical drive 10 via the card reader 11 in order to test the working performance of the card reader 11 by comparing the two sets of data. Detailed description of step S15 is provided below in relation to FIG. 4.

Otherwise, if, in step S13, the card reader 11 does not match the portable storage device 2, in step S16, the testing unit 12 displays error information through a screen of the computer 1.

FIG. 4 is a flowchart illustrating step S15 in detail, namely testing the working performance of the card reader 11. In step S20, the information obtaining module 121 obtains a working state of the portable storage device 2. In step S21, the information obtaining module 121 determines whether the portable storage device 2 is write-protected. If the portable storage device 2 is write-protected, in step S22, the testing unit 12 displays information that it is write-protected. Otherwise, if the portable storage device 2 is not write-protected, that is to say, data of the portable storage device 2 can be written in addition to being read, in step S23, the backing up module 123 selects a start location and an end location of a data block in the portable storage device 2. In step S24, the backing up module 123 backs up data of the data block insuring existing data of the portable storage device 2 are not destroyed. In step S25, the verifying module 124 writes data into the data block, and reads the corresponding data from the data block by the card reader 11. In step S26, the verifying module compares the two sets of data in order to determine whether the card reader 11 can read and write the data of the portable storage device 2 correctly, thus obtaining the working performance of the card reader 11. Then, in step S27, the backing up module 123 restores the data that are backed up, to make sure that the data of the portable storage device 2 are kept complete.

Although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. A system for testing a card reader comprising a computer and a portable storage device, the card reader being installed in the computer and connected with the portable storage device, the computer comprising a plurality of logical drives and a testing unit, the testing unit comprising:
an information obtaining module for obtaining information on the logical drives, the card reader, and the portable storage device;
an identifying module for selecting a logical drive assigned to the card reader, and for determining whether the card reader port matches the portable storage device format; and
a verifying module for testing the working performance of the card reader.

2. The system according to claim 1, further comprising a backing up module for backing up data of the portable storage device to the logical drive corresponding to the card reader.

3. The system according to claim 1, wherein the card reader can transfer data between the computer and the portable storage device.

4. The system according to claim 3, wherein the portable storage device is one of floppy diskette, a compact disc, a portable hard disk, a flash memory card.

5. The system according to claim 1, wherein the information comprises: the type of each logical drive, a port protocol of the card reader, and a working state of the portable storage device.

6. The system according to claim 5, wherein the working state of the portable storage device is either write-protected or not.

7. A computer-based method for testing a card reader, the method comprising the steps of:
obtaining information on logical drives of a computer, a card reader, and a portable storage device connected to the card reader;
selecting a logical drive assigned to the card reader from a set of logical drives, and determining whether the card reader port matches the portable storage device format according to the information on the card reader and the portable storage device; and
testing the working performance of the card reader by comparing data written into the portable storage device and data read from the portable storage device.

8. The method according to claim 7, wherein the information comprises: the type of each logical drive, a port protocol of the card reader, and a working state of the portable storage device.

9. The method according to claim 7, further comprising the step of:
displaying error information if the card reader port does not match the portable storage device format.

10. The method according to claim 7, wherein the step of testing the working performance of the card reader comprises the steps of:
obtaining a working state of the portable storage device;
determining whether the portable storage device is write-protected;
displaying information if the portable storage device is write-protected;
selecting a start location and an end location of a data block in the portable storage device if the portable storage device is not write-protected;
backing up data of the data block;
writing data to the data block;
reading the data from the data block by the card reader;
comparing the two sets of data to obtain the work performance of the card reader; and
restoring the data that were backed-up.
